(19) United States
(12) Patent Application Publication
(10) Pub. No.: US 2014/0047744 A1
(43) Pub. Date: Feb. 20, 2014

(54) BATES WIPERSOX

(71) Applicant: Willie B Bates, II, Chattanooga, TN (US)

(72) Inventor: Willie B Bates, II, Chattanooga, TN (US)

(21) Appl. No.: 13/931,851

(22) Filed: Aug. 19, 2013

Related U.S. Application Data
(60) Provisional application No. 61/691,110, filed on Aug. 20, 2012.

(51) Int. Cl. G09F 21/04

(52) U.S. Cl. CPC G09F 21/048
USPC 40/591

(57) ABSTRACT

A Bates Wipersox fits over the vehicles wiper blade and wiper arm to be positioned on the windshield of a stationary automobile and is designed for advertising. A vehicles wiper blade could park on either side of the windshield, so the lower section of the wipersox has an opening on both ends to receive the wiper blade and wiper arm allowing for convenient use of the device on either side of the windshield. Constructed of heavy duty marine vinyl, the finished rectangle shaped device is 11″ in height and 24″ in length; comprised of an upper and lower section for advertising, with the lower section having equal openings on both ends. The wipersox is prominently displayed on the windshield to attract potential customers and removes easily for trunk storage and later use.

### CROSS-REFERENCE TO RELATED APPLICATIONS

This application claims the benefit of U.S. Provisional Application No. 61/691,110, which is incorporated herein by reference.

### TECHNICAL FIELD

This invention relates to windshield wiper blades and wiper arm of a vehicle. The Bates Wipersox, herein called apparatus, is invented for advertising. Advertising is used to describe any type of photo, slogan, or message placed directly on the invention.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

Advertising can be expensive for small businesses and the average consumer. Digital and electronic advertising mediums such as television, radio, or internet could hurt a company's budget. A less expensive form of advertising, i.e. newspaper, has lost its appeal in this digital age. As consumers search for less expensive and popular ways to advertise, less traditional means of advertising such as paper, cardboard, or poster usually end with the advertisement being blown away by wind, destroyed by weather elements or ending as trash on public streets. Further, advertising using methods of paper, cardboard and poster advertisements placed on businesses, nailed to trees or taped to a surface are eventually removed by a business owner or the city because of the eyesore. Citizens and business owners complain alike about the amount of posters and paper hung in the neighborhood attempting to attract visibility to a product, slogan, to find a missing person, or support a favorite political candidate. Families wishing to advertise the photo of a lost child or elderly parent are left to depend on local news media to attract attention to their issue because they are unable to afford to pay for television, radio or bill board. Moreover, the aforementioned advertising mediums are used for a limited amount of time because of cost.

As for private citizens, many local ordinances now restrict or prohibit the use of advertising using paper on city property. Further, many residents remove the advertisement because it negatively impacts property value and the overall perception of a neighborhood. In short, there is no way to productively advertise without paying for expensive radio, television or internet ads or having your advertisement removed from city property, or destroyed by weather. Those wishing to advertise a missing loved one and who may not have the means to pay for advertising, are left to depend on the mercy of local media to share their story. They are forced to use paper advertising, which is subsequently removed, either by weather or resident. Small businesses that do not have a large budget for television, radio or internet advertising, are forced to rely on advertising with flyers and posters or simply do not advertise at all, possibly hurting their bottom line because of an inability to attract new customers for lack of advertising. Newspaper advertising is even less effective because of a shift to digital. For the foregoing reasons, there is a need for an apparatus that inexpensively advertises while using the largest part of the vehicle, the windshield, is able to be reused, and thus reduces the costs of repeat digital or electronic advertisement.

### SUMMARY

In accordance with the present invention, an apparatus used for advertising and the apparatus' use of the wiper blade and wiper blade arm of a vehicle, particularly pertaining to a sleeve that slips over the wiper blade and wiper blade arm. When the automobile is not in use, citizens and businesses advertise slogans, promote political candidates and advertise missing family members by placing graphics or images on the apparatus. The apparatus is constructed of heavy duty marine vinyl and can be used in all weather conditions.

Another aspect of the apparatus, a method of advertising utilizing the stationary vehicles wiper blade and wiper blade arm, the invention is to be the same length as the wiper blade and wiper blade arm, allowing for maximum exposure of the advertisement.

Advantages of this apparatus include the following: On a stationary vehicle, the invention provides a way to advertise on the windshield while utilizing the wiper blade and wiper blade arm. When the apparatus advertises missing children, unlike posters or flyers, the apparatus remains in place without fear of being removed or blown away during windy or rainy conditions. The applied graphics and images are made of weather proof material and are able to be used in all weather conditions. The apparatus is positioned on a personal or commercial vehicle, reducing the likelihood of breaking city or county code or angering property owners. Another advantage is how easily the apparatus is positioned and removed from the windshield utilizing the wiper blade and wiper blade arm. Yet another advantage of this invention is the ease of transport. The apparatus can be placed in the trunk of the vehicle until ready to use again. Further advantage is the capability of advertisement wherever the vehicle travels. If mall or grocery shopping, attending a sports event or simply advertising outside the business, the apparatus is placed on a stationary vehicles wiper blade and wiper blade arm and displayed until removed by the vehicle owner before the car is placed in motion. Other advantages is the advertisement can be displayed as many times as needed, without incurring additional charges to further promote the advertisement, as is the case when television, radio or internet is used as the advertising medium. These and other features, aspects, and advantages of the present invention will become better understood with reference to the following description and claims.

### BRIEF DESCRIPTION OF THE SEVERAL VIEWS OF THE DRAWINGS

FIG. 1 is the windshield view illustrating the embodiment of the invention.

FIG. 2 is a frontal view demonstrating the apparatus as seen when placed on the vehicle.

FIG. 3 is a side view of the invention.

### DETAILED DESCRIPTION OF THE INVENTION

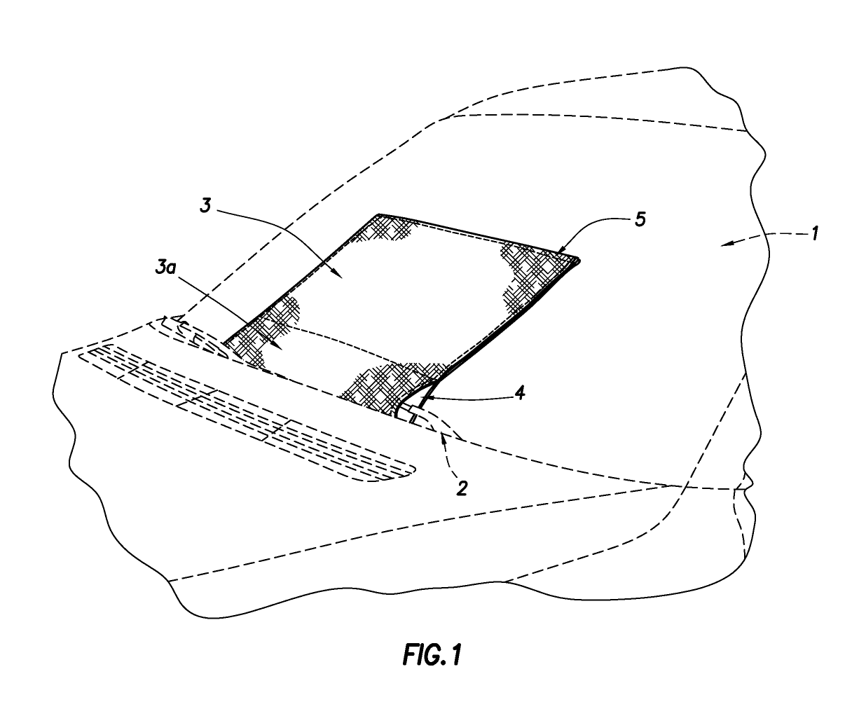

Referring to FIG. 1, a side view of a windshield of a vehicle is shown as 1. 2 illustrates the apparatus as seen on the wiper blade of the vehicle. 3 and 3a is the apparatus shown illustrating the upper and lower section used for advertising. 4 illustrates how the apparatus opens to accept the wiper blade and wiper blade arm as it is placed on the windshield. 5 illustrates the texture of the apparatus, a heavy duty marine vinyl, in which graphics and logos are applied creating the advertisement.

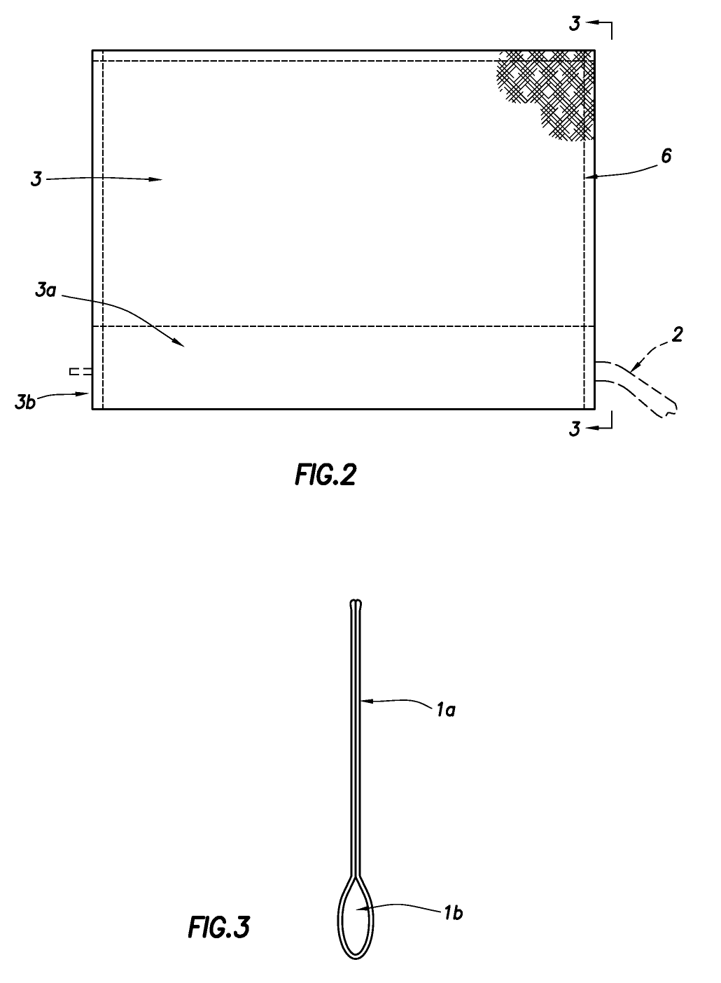

Referring to FIG. 2, 3 illustrates a rectangle area 13 inches in height×24 inches in length for advertising; 3a illustrates a lower section measuring 5 inches×24 inches used for advertising, and is illustrated with a horizontal stich sewn the length of the apparatus, creating the lower section equally open sleeve that houses the wiper blade and wiper blade arm.

3b shows an equal opening to allow the apparatus to fully cover a wiper blade and wiper blade arm. This allows the apparatus to comfortably fit conventional wiper blades. 2 illustrates a wiper blade inside the apparatus. 6 shows stitchery sewn over the entire apparatus.

Referring to FIG. 3, 1a illustrates a double seam that is created once the heavy duty marine vinyl is sewn together after the initial fold from being cut. The double seam is sewn over the entire invention to ensure water is unable to enter. 1b illustrates an equal opening of the sleeve on both ends of the invention allowing vehicles that have wiper blades that park either on the driver's side or the passenger side to make use of the invention.

To use the apparatus, a person would lift the wiper blade from the windshield and slide the apparatus over the wiper blade and wiper blade arm until the apparatus is positioned on the windshield exposing the advertisement. The apparatus will lay flat on the windshield.

A method of fabricating the apparatus will now be described. The heavy duty marine vinyl is first cut using industrial grade shears. The material is cut at least 2 inches larger than the finished product will be to allow for finished sizing and double-seam. The material is cut 13 inches by 26 inches in a rectangle template.

Using a PFAFF 438 ZigZag industrial sewing machine, upholstery nylon thread and heavy duty PFAFF needle, the unfinished side of the vinyl is faced up, the side for advertising is face down. The edges of the apparatus are folded 2 inches inward and sewn hemstitch, creating a border around the entire apparatus. The cut vinyl is then manually folded, with the unfinished side inward, bringing the edges together shaping the rectangle. The borders are then hemstitched once more around the apparatus, creating the double seam as illustrated in 1a, ensuring to end the hemstitch 5 inches from the bottom of the apparatus creating the lower section.

To create the lower section sew a straight stich 5 inches from the bottom of the apparatus, stitching horizontally from one end of the apparatus to the other. This creates the upper and lower section of the apparatus used for advertising; the lower section houses the wiper blade and wiper arm allowing the apparatus to be positioned on the windshield. The lower section has equal openings on both ends of the apparatus to allow for use on either side of the windshield.

Although the present invention has been described in considerable detail with reference to certain preferred versions thereof, other versions are possible. Therefore, the spirit and scope of the appended claims should not be limited to the description of the preferred versions contained therein.

What is claimed is:

1. A wipersox, comprising:
an upper and lower section, the advertising device opens on both ends to receive the wiper blade and wiper blade arm of a vehicle to assist with advertising while positioned on the windshield of an automobile.

2. The apparatus of claim 1 further comprising wherein a lower section has equal openings on both ends for receiving the wiper blade and wiper blade arm.

3. The apparatus of claim 1 wherein the material is flexible and made of heavy duty marine vinyl.

4. The apparatus of claim 1, wherein the sleeve has a length in a range of 24 inches.

5. The apparatus of claim 2, wherein the both open ends of the lower section sleeve is 5 inches in width.

6. The apparatus of claim 1, wherein the upper section is for advertising.

7. The apparatus of claim 1, wherein the lower section is for advertising.

8. The apparatus of claim 1, wherein the upper and lower section is divided by stitchery sewed the length of the apparatus.

9. The apparatus of claim 1, wherein the height has a range of about 11 inches.
